(19) United States
(12) Patent Application Publication
(10) Pub. No.: US 2026/0089445 A1
(43) Pub. Date: Mar. 26, 2026

(54) METHOD, DEVICE FOR MATCHING LEFT AND RIGHT CHANNELS OF EARPHONES, CLIP-ON EARPHONES AND STORAGE MEDIUM

(71) Applicant: GOERTEK INC., Weifang (CN)

(72) Inventors: Haiyong WANG, Weifang (CN); Bin JIANG, Weifang (CN)

(21) Appl. No.: 19/404,628

(22) Filed: Dec. 1, 2025

Related U.S. Application Data
(63) Continuation of application No. PCT/CN2025/084567, filed on Mar. 25, 2025.

(30) Foreign Application Priority Data
Mar. 28, 2024 (CN) 202410371059.5

(51) Int. Cl. H04R 5/02; G06F 3/16; H04R 5/033; H04R 5/04

(52) U.S. Cl. CPC H04R 5/02; G06F 3/16; H04R 5/0335; H04R 5/04; H04R 2205/022

(57) ABSTRACT

A method and a device for matching left and right channels of an earphones, a clip-on earphones, and a storage medium. The method includes: obtaining, in response to detecting that the clip-on earphone is worn, three-axis acceleration information detected by the three-axis acceleration sensor; determining corresponding wearing positions of the first earphone and the second earphone according to the three-axis acceleration information; and adjusting, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

### CROSS-REFERENCE TO RELATED APPLICATIONS

This application is a continuation application of International Application No. PCT/CN2025/084567, filed on Mar. 25, 2025, which claims priority to Chinese Patent Application No. 202410371059.5, filed on Mar. 28, 2024. All of the aforementioned applications are incorporated herein by reference in their entireties.

### TECHNICAL FIELD

The present application relates to the technical field of earphone, and in particular to a method and a device for matching left and right channels of an earphone, a clip-on earphone, and a storage medium.

### BACKGROUND

With the development of new technologies, open wearable stereo (OWS) earphones, such as clip-on earphones, have become increasingly popular. Compared with true wireless stereo (TWS) earphones, clip-on earphones are more ear-friendly, do not cause hearing damage, provide a more comfortable wearing experience, and are more suitable for long-term use. Because clip-on OWS earphones are worn without being inserted into the ear, they can have identical left and right designs and can be worn interchangeably, which distinguishes them from conventional in-ear earphones.

The clip-on earphones include a left earphone and a right earphone. The left earphone outputs a left channel, and the right earphone outputs a right channel. When the stereo earphones are worn on a user's ears, the left earphone is in contact with the user's left ear, and the right earphone is in contact with the user's right ear, so that the left ear receives the left channel and the right ear receives the right channel. During wearing, the relative positions of the left earphone and the right earphone cannot be interchanged; otherwise, it directly affects the fidelity of the sound source and the resolution of the audio frequency.

To achieve a perfect sound output effect, the user must first identify the left and right sides before wearing the clip-on earphones. The current solution is to mark the clip-on earphones with identifiers such as “L” and “R.” However, this requires manual identification before wearing to avoid reversed placement, which brings inconvenience to the user.

### SUMMARY

The main objective of the present application is to provide a method and a device for matching the left and right channels of earphones, a clip-on earphone and a storage medium, aiming to solve the technical problem in the related art that requires manually confirming whether the left and right headphones are worn correctly, which leads to poor usability of clip-on earphones.

In order to achieve the above objective, the present application provides a method for matching left and right channels of earphones, which is applied to a clip-on earphone, where a first earphone and a second earphone of the clip-on earphone are each provided with a three-axis acceleration sensor, and the method includes:
obtaining, in response to detecting that the clip-on earphone is worn, three-axis acceleration information detected by the three-axis acceleration sensor;
determining corresponding wearing positions of the first earphone and the second earphone according to the three-axis acceleration information; and
adjusting, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

In an embodiment, the determining corresponding wearing positions of the first earphone and the second earphone according to the three-axis acceleration information includes:
determining a component direction of the three-axis acceleration information in a vertical direction; and
determining the corresponding wearing positions of the first earphone and the second earphone according to the component direction.

In an embodiment, the determining the corresponding wearing positions of the first earphone and the second earphone according to the component direction includes:
determining wearing posture information corresponding to the first earphone and the second earphone according to the component direction; and
determining the corresponding wearing positions of the first earphone and the second earphone according to the wearing posture information.

In an embodiment, the determining the corresponding wearing posture information of the first earphone and the second earphone according to the component direction includes:
in response to that a component direction corresponding to three-axis acceleration information of the first earphone is a positive direction of a Z axis, determining that wearing posture information corresponding to the first earphone is a first posture;
in response to that a component direction corresponding to three-axis acceleration information of the first earphone is a negative direction of the Z axis, determining that wearing posture information corresponding to the first earphone is a second posture;
in response to that a component direction corresponding to three-axis acceleration information of the second earphone is the positive direction of the Z axis, determining that wearing posture information corresponding to the second earphone is the first posture; and
in response to that a component direction corresponding to three-axis acceleration information of the second earphone is the negative direction of the Z axis, determining that wearing posture information corresponding to the second earphone is the second posture.

In an embodiment, the determining the corresponding wearing positions of the first earphone and the second earphone according to the wearing posture information includes:
in response to that the wearing posture information corresponding to the first earphone is the first posture, determining that a wearing position corresponding to the first earphone is a left ear wearing position;
in response to that the wearing posture information corresponding to the first earphone is the second posture, determining that the wearing position corresponding to the first earphone is a right ear wearing position;
in response to that the wearing posture information corresponding to the second earphone is the first posture, determining that the wearing position corresponding to the second earphone is the left ear wearing position; and
in response to that the wearing posture information corresponding to the second earphone is the second posture, determining that the wearing position corresponding to the second earphone is the right ear wearing position.

In an embodiment, the determining the corresponding wearing posture information of the first earphone and the second earphone according to the component direction includes:
in response to that a component direction corresponding to three-axis acceleration information of the first earphone is a positive direction of a Z axis and a component value in the positive direction of the Z axis matches a gravity acceleration value, determining that wearing posture information corresponding to the first earphone is a first posture;
in response to that a component direction corresponding to three-axis acceleration information of the first earphone is a negative direction of the Z axis and a component value in a negative direction of the Z axis matches the gravity acceleration value, determining that wearing posture information corresponding to the first earphone is a second posture;
in response to that a component direction corresponding to three-axis acceleration information of the second earphone is the positive direction of the Z axis and a component value in the positive direction of the Z axis matches the gravity acceleration value, determining that wearing posture information corresponding to the second earphone is the first posture; and
in response to that a component direction corresponding to three-axis acceleration information of the second earphone is the negative direction of the Z axis and a component value in the negative direction of the Z axis matches the gravity acceleration value, determining that wearing posture information corresponding to the second earphone is the second posture.

In an embodiment, the first earphone and the second earphone are each further provided with a capacitive touch sensor, and the method further includes:
obtaining capacitance sensing information detected by the capacitive touch sensor; and
determining whether the clip-on earphone is worn according to the capacitance sensing information.

In addition, the present application further provides a device for matching left and right channels of earphones, applied to a clip-on earphone, where a first earphone and a second earphone of the clip-on earphone are each provided with a three-axis acceleration sensor, the device includes:
an acquisition module configured to obtain, in response to detecting that the clip-on earphone is worn, three-axis acceleration information detected by the three-axis acceleration sensor;
a determination module configured to determine corresponding wearing positions of the first earphone and the second earphone according to the three-axis acceleration information; and
an adjustment module configured to, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

The present application further provides a clip-on earphones, which is a physical device and includes a memory, a processor, a behind-the-ear compartment, a speaker compartment, and a connecting bridge connecting the behind-the-ear compartment and the speaker compartment, where:
the speaker compartment is provided with an acoustic module including a speaker, and the behind-the-ear compartment is provided with a power supply module and an acceleration sensor;
the power supply module is configured to provide power to the clip-on earphone;
the acceleration sensor is configured to detect three-axis acceleration information of the clip-on earphone;
the memory is configured to store a program for matching left and right channels of earphones; and
the processor is configured to execute the program for matching left and right channels of earphones and, when executing the program for matching left and right channels of earphones, implement the method for matching left and right channels of earphones

The present application further provides a computer-readable storage medium, on which a program for implementing a method for matching left and right channels of earphones is stored, where when the program for implementing the method for matching left and right channels of earphones is executed by a processor, the above-mentioned method for matching left and right channels of earphones is implemented.

The present application further provides a computer program product, including a computer program, which implements the above-mentioned method for matching left and right channels of earphones when executed by a processor.

The present application discloses a method for matching left and right channels of earphones, a device for matching left and right channels of earphones, a clip-on earphone, and a storage medium. The method for matching left and right channels of earphones is applied to a clip-on earphone, where a first earphone and a second earphone of the clip-on earphone are each provided with a three-axis acceleration sensor. The technical solution of the method for matching left and right channels of earphones is that, in response to detecting that the clip-on earphone is worn, three-axis acceleration information detected by the three-axis acceleration sensor is obtained, and corresponding wearing positions of the first earphone and the second earphone are determined according to the three-axis acceleration information. Based on the corresponding wearing positions of the first earphone and the second earphone, left and right channels of a speaker of the clip-on earphone are adjusted so that the left channel corresponds to the earphone in the left ear wearing position, and the right channel corresponds to the earphone in the right ear wearing position. In this way, automatic matching between the left and right channels and the left and right ears is achieved, overcoming the inconvenience in the related art where markings such as “L” and “R” must be manually checked to avoid reversed wearing, thereby improving the usability of clip-on earphones. The method effectively enables users to wear earphones without distinguishing between the left and right channels in advance, ensuring that the audio signals of the left and right channels are always correct regardless of how the clip-on earphones are worn, thereby enhancing the user's auditory experience.

### BRIEF DESCRIPTION OF THE DRAWINGS

FIG. 1 is a flowchart of a method for matching left and right channels of earphones according to an embodiment of the present application.

FIG. 2 is a flowchart of the method for matching left and right channels of earphones according to an embodiment of the present application.

FIG. 3 is a flowchart of the method for matching left and right channels of earphones according to an embodiment of the present application.

FIG. 4 is a flowchart of the method for matching left and right channels of earphones according to an embodiment of the present application.

FIG. 5 is a flowchart of the method for matching left and right channels of earphones according to an embodiment of the present application.

FIG. 6 is a flowchart of the method for matching left and right channels of earphones according to an embodiment of the present application.

FIG. 7 is a flowchart of the method for matching left and right channels of earphones according to an embodiment of the present application.

FIG. 8 is a schematic diagram of a wearing posture of a clip-on earphones according to an embodiment of the present application in a worn state from one view.

FIG. 9 is a schematic diagram of the clip-on earphones in one view according to an embodiment of the present application.

FIG. 10 is a schematic diagram of a clip-on earphones in another view according to an embodiment of the present application.

FIG. 11 is a diagram showing three-axis acceleration information when clip-on earphones are worn on the left and right ears according to an embodiment of the present application.

The realization of the purpose, functional features and advantages of the present application will be further described with reference to the embodiments and the accompanying drawings.

### DETAILED DESCRIPTION OF THE EMBODIMENTS

To make the above-mentioned purposes, features, and advantages of the present application more clearly understood, the technical solutions in the embodiments of the present application will be clearly and completely described below in conjunction with the accompanying drawings in the embodiments of the present application. Obviously, the described embodiments are only part of the embodiments of the present application, not all of the embodiments. Based on the embodiments in the present application, all other embodiments obtained by those skilled in the art without making any creative work are within the scope of protection of the present application.

A clip-on earphone includes a left earphone and a right earphone. The left earphone is configured to output a left channel, and the right earphone is configured to output a right channel. When the stereo earphone is worn by a user, the left earphone contacts a left ear of the user, and the right earphone contacts a right ear of the user, so that the left ear receives the left channel and the right ear receives the right channel. During wearing, a relative position between the left earphone and the right earphone cannot be interchanged; otherwise, fidelity of a sound source and resolution of audio frequencies will be directly affected.

To achieve a perfect sound quality output effect, a user needs to confirm left and right sides before wearing the clip-on earphone. A current solution is to mark identifiers such as “L” and “R” on the clip-on earphone. However, this requires manual confirmation to avoid reverse wearing, which brings inconvenience to the user.

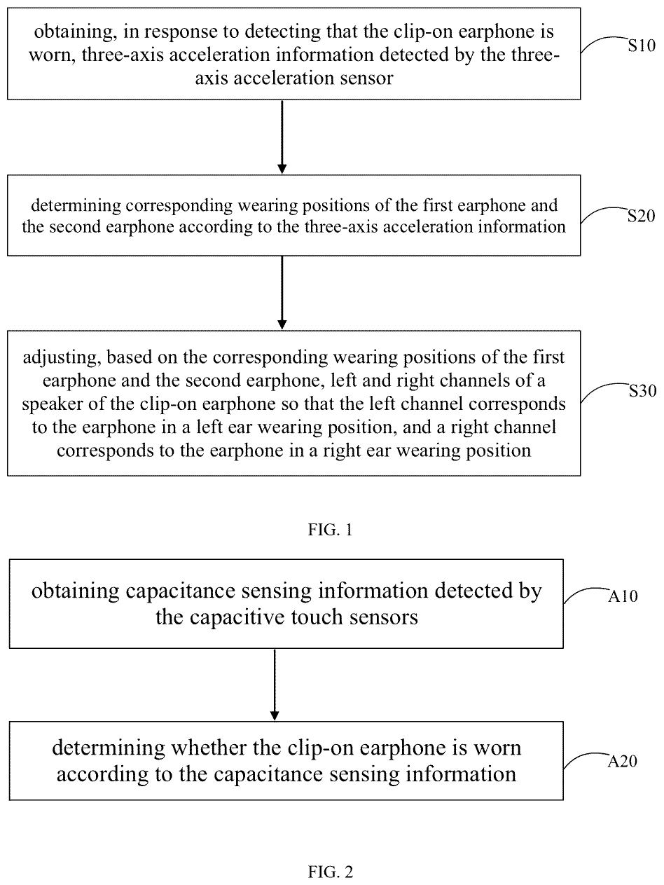

Based on this, as shown in FIG. 1, which is a flowchart of a method for matching left and right channels of earphones according to an embodiment of the present application. The method for matching left and right channels of earphones is applied to clip-on earphones, where a first earphone and a second earphone of the clip-on earphones are each provided with a three-axis acceleration sensor. The method includes:

Step S10, obtaining, in response to detecting that the clip-on earphone is worn, three-axis acceleration information detected by the three-axis acceleration sensor.

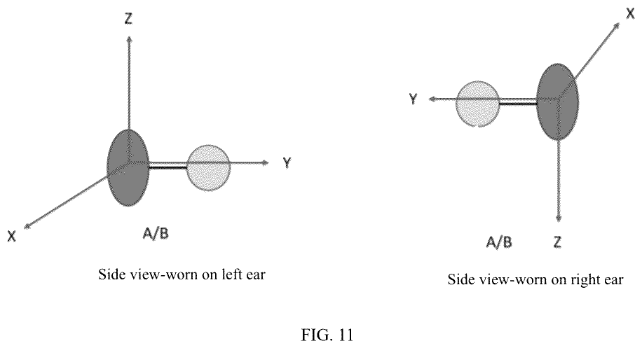

As those skilled in the art will appreciate, the clip-on earphones include two single earphones, namely a first earphone and a second earphone. As shown in FIG. 9 and FIG. 10, FIG. 9 illustrates a clip-on earphone in one view according to an embodiment of the present application, and FIG. 10 illustrates the clip-on earphone in another view according to an embodiment of the present application. A single earphone includes a speaker compartment 3, a behind-the-ear compartment 1, and a connecting bridge 2 connecting the speaker compartment and the behind-the-ear compartment. A speaker compartment region refers to a region corresponding to the speaker compartment 3. It is understood by those skilled in the art that for a clip-on earphone, an acoustic module is generally provided in the speaker compartment 3. The acoustic module includes a speaker, and may further include a microphone, which is not specifically limited in this embodiment. The behind-the-ear compartment 1 generally includes a power supply module configured to provide power. The behind-the-ear compartment 1 may further include a noise reduction module and a communication module, which are not specifically limited in this embodiment. The speaker is used to play audio of a left channel or a right channel, and the power supply module is used to provide power for the single earphone. The communication module is used for information interaction between the single earphone and other electronic devices connected for communication with the single earphone. The acceleration sensor is used to detect three-axis acceleration information of the single earphone. The microphone is used to collect ambient audio, and the noise reduction module is used to perform adaptive noise reduction based on a preset noise reduction algorithm on the ambient audio collected by the microphone. The preset noise reduction algorithm may be an Active Noise Control (ANC) algorithm, an Environmental Noise Cancellation (ENC) algorithm, a Digital Signal Processing (DSP) algorithm, or a Clear Voice Capture (CVC) algorithm. For these noise reduction algorithms, those skilled in the art have conducted in-depth research, and thus details are not repeated herein.

Those skilled in the art will know that a three-axis acceleration sensor works based on the basic principle of acceleration, and acceleration is a space vector.

In an embodiment, the first earphone and the second earphone are each further provided with a capacitive touch sensor, as shown in FIG. 2, and the method further includes:

Step A10, obtaining capacitance sensing information detected by the capacitive touch sensor; and

Step A20, determining whether the clip-on earphone is worn according to the capacitance sensing information.

The present application obtains capacitance sensing information detected by the capacitive touch sensors, and accurately detects whether the ear clip earphones are worn based on the capacitance sensing information.

After step S10, step S20, determining corresponding wearing positions of the first earphone and the second earphone according to the three-axis acceleration information, is executed.

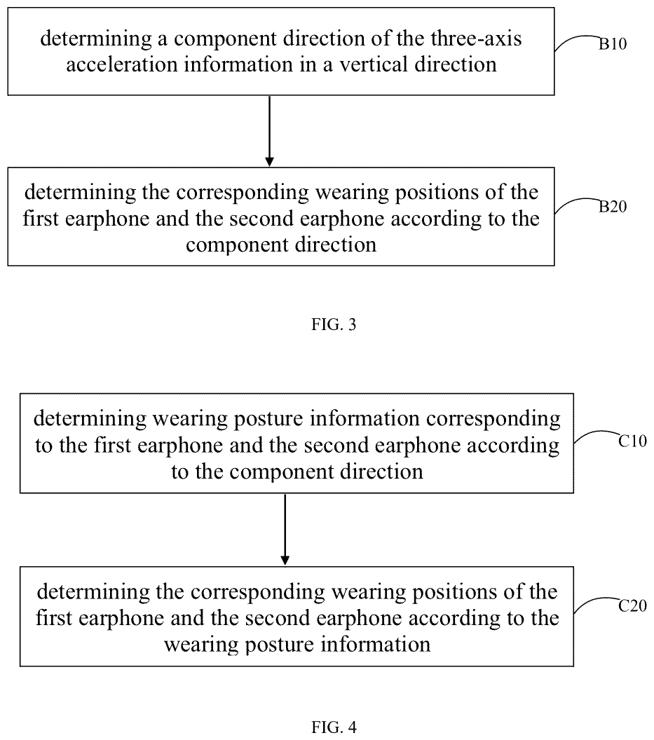

In an embodiment, as shown in FIG. 3, the determining corresponding wearing positions of the first earphone and the second earphone according to the three-axis acceleration information includes:

Step B10, determining a component direction of the three-axis acceleration information in a vertical direction; and

Step B20, determining the corresponding wearing positions of the first earphone and the second earphone according to the component direction.

In this embodiment, it can be understood that when the first earphone is worn on the left ear or on the right ear, its wearing posture will be reversed. That is, if a component direction corresponding to three-axis acceleration information of the first earphone when worn on the left ear points to a positive direction of a Z axis, then a component direction corresponding to three-axis acceleration information of the first earphone when worn on the right ear points to a negative direction of the Z axis. Conversely, if a component direction corresponding to three-axis acceleration information of the first earphone when worn on the right ear points to the negative direction of the Z axis, then a component direction corresponding to three-axis acceleration information of the first earphone when worn on the left ear points to the positive direction of the Z axis. As shown in FIG. 11, FIG. 11 is a schematic diagram illustrating three-axis acceleration information when the earphones are worn on the left and right ears according to an embodiment of the present application.

The mapping relationship between three-axis acceleration information and wearing position information may be stored in advance in the first earphone, or in a cloud server with which the first earphone is registered and logged in. In an example, the mapping relationship stored in the first earphone or in the cloud server with which the first earphone is registered and logged in is as follows: when a component direction of the three-axis acceleration information points to a positive direction of a Z axis, the mapped wearing position information corresponds to a left ear wearing position; and when the component direction of the three-axis acceleration information points to a negative direction of the Z axis, the mapped wearing position information corresponds to a right ear wearing position. Based on the stored mapping relationship, it is convenient to subsequently determine a wearing position corresponding to the first earphone according to the three-axis acceleration information.

Similarly, when the second earphone is worn on the left ear or on the right ear, its wearing posture will be reversed. That is, if a component direction corresponding to three-axis acceleration information of the second earphone when worn on the left ear points to a positive direction of a Z axis, then a component direction corresponding to three-axis acceleration information of the second earphone when worn on the right ear points to a negative direction of the Z axis. Conversely, if a component direction corresponding to three-axis acceleration information of the second earphone when worn on the right ear points to the negative direction of the Z axis, then a component direction corresponding to three-axis acceleration information of the second earphone when worn on the left ear points to the positive direction of the Z axis, as shown in FIG. 11.

The mapping relationship between three-axis acceleration information and wearing position information may be stored in advance in the second earphone, or in a cloud server with which the second earphone is registered and logged in. In an example, the mapping relationship stored in the second earphone or in the cloud server with which the second earphone is registered and logged in is as follows: when a component direction of the three-axis acceleration information points to a negative direction of a Z axis, the mapped wearing position information corresponds to a right ear wearing position; and when the component direction of the three-axis acceleration information points to a positive direction of the Z axis, the mapped wearing position information corresponds to a left ear wearing position. Based on the stored mapping relationship, it is convenient to subsequently determine a wearing position corresponding to the second earphone according to the three-axis acceleration information.

After step S20, step S30, adjusting, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position, is executed.

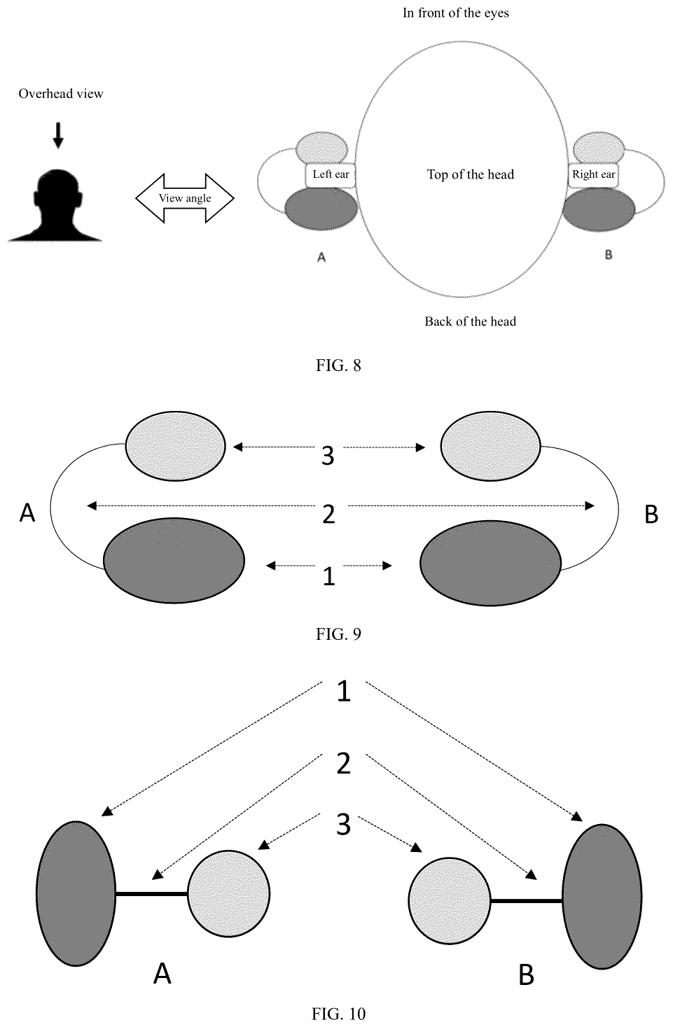

As shown in FIG. 8, FIG. 8 is a schematic diagram of a wearing posture of a clip-on earphone in a wearing state from one view (viewed from the top of the head) according to an embodiment of the present application. The first earphone and the second earphone are identical single earphone units, there is no need to distinguish between left and right earphones manually, and a user can wear them freely. The earphones automatically distinguish and configure left and right channels according to the side on which they are worn by the user. Since, when the earphones are first worn, the user's head is generally in an upright posture rather than a lying or inverted posture, the method for matching left and right channels of earphones of the present embodiment can easily achieve an automatic detection scheme for left and right channels of open-type earphones, facilitating user wearing and use. The user does not need to distinguish between left and right sides, allowing blind selection and wearing. Moreover, the clip-on earphone of the present embodiment has a simple structure and a low hardware cost for implementing the method for matching left and right channels of earphones.

In an embodiment, an acceleration sensor may be provided in the behind-the-ear compartment. During factory calibration, coordinate calibration is performed according to a normal wearing posture. For example, each single earphone is subjected to the same coordinate calibration, in which a Z axis points upward in the normal wearing posture. It is defined that, during normal wearing, when the earphone detects the Z axis pointing upward, the corresponding channel is the left channel, as shown in the side view schematic diagram of left-ear wearing in FIG. 11. When the earphone detects the Z axis pointing downward during wearing, the corresponding channel is the right channel, as shown in the side view schematic diagram of right-ear wearing in FIG. 11. When the earphones are worn in a correct posture, one earphone necessarily has the Z axis pointing upward and the other has the Z axis pointing downward, thereby completing left and right channel configuration. After the earphones leave the factory, left and right channel identification needs to be completed in cooperation with the wearing detection function based on acceleration sensing data of the earphones.

The embodiment of the present application discloses a method and a device for matching left and right channels of earphones, a clip-on earphone, and a storage medium. The method for matching left and right channels of earphones is applied to a clip-on earphone, and a first earphone and a second earphone of the clip-on earphone are each provided with a three-axis acceleration sensor. The technical solution of the method for matching left and right channels of earphones according to the embodiment of the present application is as follows. In response to detecting that the clip-on earphone is worn, three-axis acceleration information detected by the three-axis acceleration sensor is obtained. According to the three-axis acceleration information, wearing positions corresponding to the first earphone and the second earphone are determined. Based on the wearing positions corresponding to the first earphone and the second earphone, left and right channels of a speaker of the clip-on earphone are adjusted so that the left channel corresponds to the earphone in a left ear wearing position and the right channel corresponds to the earphone in a right ear wearing position. Therefore, automatic matching between the left and right channels and the left and right ears is realized, overcoming the inconvenience in the related art in which identifiers such as “L” and “R” are marked on the earphones and manual confirmation is required to avoid reverse wearing. The method improves the convenience of using the clip-on earphone, effectively enabling a user to wear the earphone without distinguishing left and right channels in advance. Regardless of how the clip-on earphone is worn, the obtained sound signals of the left and right channels are always correct, thereby improving the user's auditory experience.

As shown in FIG. 4, in an embodiment, the determining the corresponding wearing posture information of the first earphone and the second earphone according to the component direction includes:

Step C10, determining wearing posture information corresponding to the first earphone and the second earphone according to the component direction; and

Step C20, determining the corresponding wearing positions of the first earphone and the second earphone according to the wearing posture information.

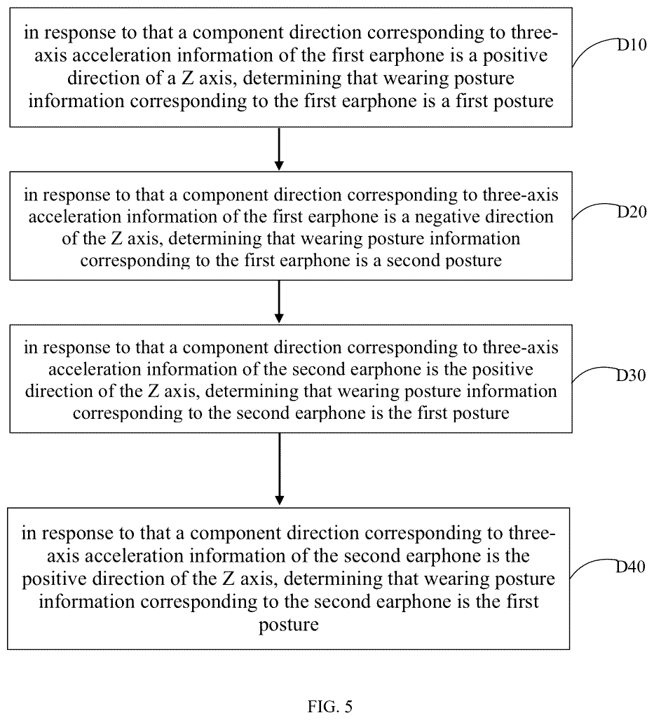

As shown in FIG. 5, in an embodiment, the determining the corresponding wearing posture information of the first earphone and the second earphone according to the component direction includes:

Step D10, in response to that a component direction corresponding to three-axis acceleration information of the first earphone is a positive direction of a Z axis, determining that wearing posture information corresponding to the first earphone is a first posture;

Step D20, in response to that a component direction corresponding to three-axis acceleration information of the first earphone is a negative direction of the Z axis, determining that wearing posture information corresponding to the first earphone is a second posture;

Step D30, in response to that a component direction corresponding to three-axis acceleration information of the second earphone is the positive direction of the Z axis, determining that wearing posture information corresponding to the second earphone is the first posture; and

Step D40, in response to that a component direction corresponding to three-axis acceleration information of the second earphone is the negative direction of the Z axis, determining that wearing posture information corresponding to the second earphone is the second posture.

The embodiment of the present application determines wearing posture information corresponding to the first earphone and the second earphone according to the component direction, and determines wearing positions corresponding to the first earphone and the second earphone according to the wearing posture information. In this way, accuracy in identifying earphone wearing positions is effectively improved. By allowing the left channel to correspond to the earphone in a left ear wearing position and the right channel to correspond to the earphone in a right ear wearing position, automatic matching between the left and right channels and the left and right ears is achieved. Thus, the embodiment overcomes the inconvenience in the related art in which identifiers such as “L” and “R” are marked on the earphones and manual confirmation is required to avoid reverse wearing, thereby improving the convenience of using the clip-on earphone. The embodiment of the present application provides an open-type earphone that allows a user to wear the earphone without distinguishing between left and right ears, and the earphone can autonomously identify left and right channels during wearing, thereby avoiding the trouble for the user to distinguish between left and right earphones before wearing.

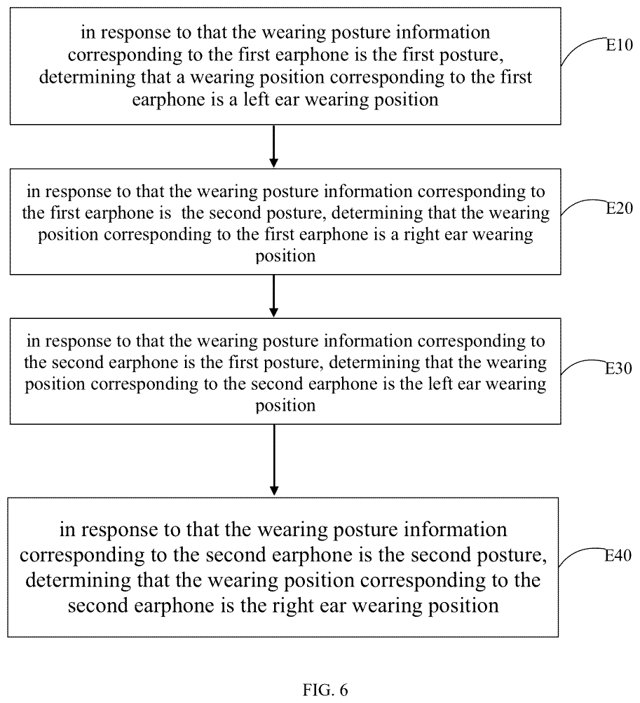

As shown in FIG. 6, in an embodiment, the determining the corresponding wearing positions of the first earphone and the second earphone according to the wearing posture information includes:

Step E10, in response to that the wearing posture information corresponding to the first earphone is the first posture, determining that a wearing position corresponding to the first earphone is a left ear wearing position;

Step E20, in response to that the wearing posture information corresponding to the first earphone is the second posture, determining that the wearing position corresponding to the first earphone is a right ear wearing position;

Step E30, in response to that the wearing posture information corresponding to the second earphone is the first posture, determining that the wearing position corresponding to the second earphone is the left ear wearing position; and

Step E40, in response to that the wearing posture information corresponding to the second earphone is the second posture, determining that the wearing position corresponding to the second earphone is the right ear wearing position.

In this embodiment, the first posture is different from the second posture. It can be understood that the second posture is formed by a 180-degree rotation or an approximately 180-degree rotation of the first posture. In an embodiment, as shown in FIG. 11, the left view in FIG. 11 illustrates a first posture corresponding to a target earphone when worn on a left ear, and the right view in FIG. 11 illustrates a second posture corresponding to the target earphone when worn on a right ear. The target earphone is the first earphone or the second earphone.

The embodiment of the present application determines that if wearing posture information corresponding to the first earphone is a first posture, a wearing position corresponding to the first earphone is a left ear wearing position; if the wearing posture information corresponding to the first earphone is a second posture, the wearing position corresponding to the first earphone is a right ear wearing position; if the wearing posture information corresponding to the second earphone is the first posture, the wearing position corresponding to the second earphone is the left ear wearing position; and if the wearing posture information corresponding to the second earphone is the second posture, the wearing position corresponding to the second earphone is the right ear wearing position. In this way, accuracy in identifying earphone wearing positions is effectively improved. By allowing the left channel to correspond to the earphone in a left ear wearing position and the right channel to correspond to the earphone in a right ear wearing position, automatic matching between the left and right channels and the left and right ears is achieved, so that users do not need to distinguish between left and right channels before wearing the earphones, and regardless of how the clip-on earphones are worn, the obtained left and right channel sound signals are always correct.

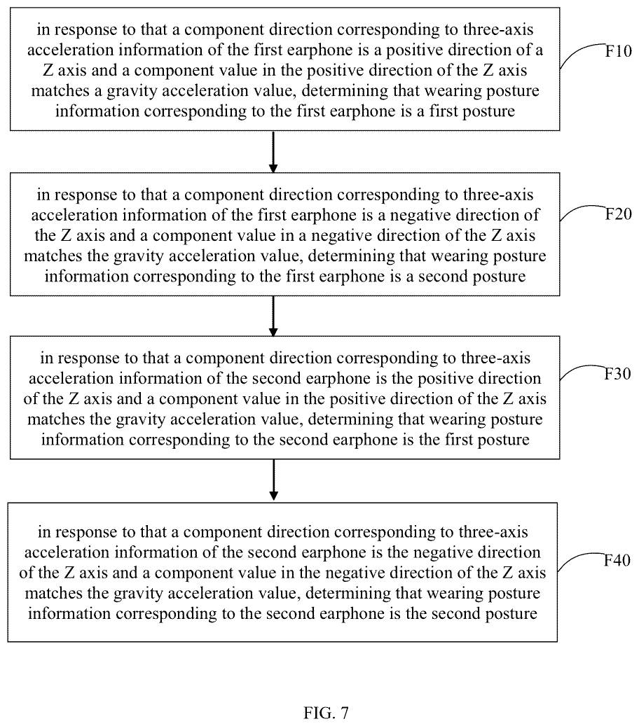

Based on the above embodiment of the present application, in another embodiment of the present application, the same or similar contents as the above embodiment can be referred to the above introduction and will not be repeated hereafter. As shown in FIG. 7, on this basis, the determining the corresponding wearing posture information of the first earphone and the second earphone according to the component direction includes:

Step F10, in response to that a component direction corresponding to three-axis acceleration information of the first earphone is a positive direction of a Z axis and a component value in the positive direction of the Z axis matches a gravity acceleration value, determining that wearing posture information corresponding to the first earphone is a first posture;

Step F20, in response to that a component direction corresponding to three-axis acceleration information of the first earphone is a negative direction of the Z axis and a component value in a negative direction of the Z axis matches the gravity acceleration value, determining that wearing posture information corresponding to the first earphone is a second posture;

Step F30, in response to that a component direction corresponding to three-axis acceleration information of the second earphone is the positive direction of the Z axis and a component value in the positive direction of the Z axis matches the gravity acceleration value, determining that wearing posture information corresponding to the second earphone is the first posture; and

Step F40, in response to that a component direction corresponding to three-axis acceleration information of the second earphone is the negative direction of the Z axis and a component value in the negative direction of the Z axis matches the gravity acceleration value, determining that wearing posture information corresponding to the second earphone is the second posture.

In this embodiment, it is understood by those skilled in the art that, when a person wears earphones, the person's head is generally in an upright position (and seldom in a lying or inverted state). Therefore, a component value in a Z-axis direction generally matches a gravity acceleration value. Based on this principle, in the embodiment of the present application, when a component direction corresponding to three-axis acceleration information of the first earphone is a positive direction of a Z axis and the component value in the positive direction of the Z axis matches the gravity acceleration value, it is determined that wearing posture information corresponding to the first earphone is a first posture; when the component direction corresponding to the three-axis acceleration information of the first earphone is a negative direction of the Z axis and the component value in the negative direction of the Z axis matches the gravity acceleration value, it is determined that wearing posture information corresponding to the first earphone is a second posture; when the component direction corresponding to the three-axis acceleration information of the second earphone is the positive direction of the Z axis and the component value in the positive direction of the Z axis matches the gravity acceleration value, it is determined that wearing posture information corresponding to the second earphone is the first posture; and when the component direction corresponding to the three-axis acceleration information of the second earphone is the negative direction of the Z axis and the component value in the negative direction of the Z axis matches the gravity acceleration value, it is determined that wearing posture information corresponding to the second earphone is the second posture. In this way, accuracy in identifying earphone wearing positions is further improved. By allowing the left channel to correspond to the earphone in a left ear wearing position and the right channel to correspond to the earphone in a right ear wearing position, automatic matching between the left and right channels and the left and right ears is achieved. As a result, users do not need to distinguish between left and right channels before wearing the earphones, and regardless of how the clip-on earphones are worn, the obtained left and right channel sound signals are always correct.

The present application further provides a device for matching left and right channels of earphones, which is applied to a clip-on earphone, where a first earphone and a second earphone of the clip-on earphone are each provided with a three-axis acceleration sensor, the device includes:
an acquisition module configured to obtain, in response to detecting that the clip-on earphone is worn, three-axis acceleration information detected by the three-axis acceleration sensor;
a determination module configured to determine corresponding wearing positions of the first earphone and the second earphone according to the three-axis acceleration information; and
an adjustment module configured to, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

In an embodiment, the determination module is further configured to:
determine a component direction of the three-axis acceleration information in a vertical direction; and
determine the corresponding wearing positions of the first earphone and the second earphone according to the component direction.

In an embodiment, the determination module is further configured to:
determine wearing posture information corresponding to the first earphone and the second earphone according to the component direction; and
determine the corresponding wearing positions of the first earphone and the second earphone according to the wearing posture information.

In an embodiment, the determination module is further configured to:
in response to that a component direction corresponding to three-axis acceleration information of the first earphone is a positive direction of a Z axis, determine that wearing posture information corresponding to the first earphone is a first posture;
in response to that a component direction corresponding to three-axis acceleration information of the first earphone is a negative direction of the Z axis, determine that wearing posture information corresponding to the first earphone is a second posture;
in response to that a component direction corresponding to three-axis acceleration information of the second earphone is the positive direction of the Z axis, determine that wearing posture information corresponding to the second earphone is the first posture; and
in response to that a component direction corresponding to three-axis acceleration information of the second earphone is the negative direction of the Z axis, determine that wearing posture information corresponding to the second earphone is the second posture.

In an embodiment, the determination module is further configured to:
in response to that the wearing posture information corresponding to the first earphone is the first posture, determine that a wearing position corresponding to the first earphone is a left ear wearing position;
in response to that the wearing posture information corresponding to the first earphone is the second posture, determine that the wearing position corresponding to the first earphone is a right ear wearing position;
in response to that the wearing posture information corresponding to the second earphone is the first posture, determine that the wearing position corresponding to the second earphone is the left ear wearing position; and
in response to that the wearing posture information corresponding to the second earphone is the second posture, determine that the wearing position corresponding to the second earphone is the right ear wearing position.

In an embodiment, the determination module is further configured to:
in response to that a component direction corresponding to three-axis acceleration information of the first earphone is a positive direction of a Z axis and a component value in the positive direction of the Z axis matches a gravity acceleration value, determine that wearing posture information corresponding to the first earphone is a first posture;
in response to that a component direction corresponding to three-axis acceleration information of the first earphone is a negative direction of the Z axis and a component value in a negative direction of the Z axis matches the gravity acceleration value, determine that wearing posture information corresponding to the first earphone is a second posture;
in response to that a component direction corresponding to three-axis acceleration information of the second earphone is the positive direction of the Z axis and a component value in the positive direction of the Z axis matches the gravity acceleration value, determine that wearing posture information corresponding to the second earphone is the first posture; and
in response to that a component direction corresponding to three-axis acceleration information of the second earphone is the negative direction of the Z axis and a component value in the negative direction of the Z axis matches the gravity acceleration value, determine that wearing posture information corresponding to the second earphone is the second posture.

In an embodiment, the acquisition module is further configured to:
obtain capacitance sensing information detected by the capacitive touch sensors; and
determine whether the clip-on earphone is worn according to the capacitance sensing information.

The device for matching left and right channels of earphones provided in the embodiment of the present application adopts the method for matching left and right channels of earphones described in the above embodiment, which can solve the technical problem in the related art that manual confirmation is required to determine whether the left and right earphones are worn reversely, resulting in poor convenience in using the clip-on earphones. Compared with the prior art, the advantageous effects of the device for matching left and right channels of earphones provided in this embodiment are the same as those of the method for matching left and right channels of earphones described in the above embodiment, and other technical features of the device for matching left and right channels of earphones are the same as those disclosed in the above embodiment of the method, which will not be repeated here.

The present application provides a clip-on earphones, which includes a memory, a processor, a behind-the-ear compartment, a speaker compartment, and a connecting bridge connecting the behind-the-ear compartment and the speaker compartment, where the speaker compartment is provided with an acoustic module including a speaker, and the behind-the-ear compartment is provided with a power supply module and an acceleration sensor; the power supply module is configured to provide power to the clip-on earphone; the acceleration sensor is configured to detect three-axis acceleration information of the clip-on earphone; the memory is configured to store a program for matching left and right channels of earphones; and the processor is configured to execute the program for matching left and right channels of earphones and, when executing the program for matching left and right channels of earphones, implement the method for matching left and right channels of earphones in the above embodiments.

The clip-on earphone provided in the embodiment of the present application adopts the method for matching left and right channels of earphones described in the above embodiment, which can solve the technical problem in the related art that manual confirmation is required to determine whether the left and right earphones are worn reversely, resulting in poor convenience in using the clip-on earphones. Compared with the prior art, the advantageous effects of the clip-on earphone provided in this embodiment are the same as those of the method for matching left and right channels of earphones described in the above embodiment, and other technical features of the clip-on earphone are the same as those disclosed in the previous embodiment of the method, which will not be repeated here.

It should be understood that each part of the present disclosure can be implemented by hardware, software, firmware, or a combination thereof. In the description of the above embodiments, specific features, structures, materials, or characteristics may be combined in any suitable manner in one or more embodiments or examples.

The foregoing description is merely specific embodiments of the present application and is not intended to limit the protection scope of the present application. Any person skilled in the art can easily conceive of variations or substitutions within the scope of the technologies disclosed in the present application, which shall all fall within the protection scope of the present application. Therefore, the protection scope of the present application shall be subject to the protection scope of the claims.

The embodiment of the present application provides a computer-readable storage medium having computer-readable program instructions stored thereon, the computer-readable program instructions being used to execute the method for matching left and right channels of earphones described in the above embodiment.

The computer-readable storage medium provided in the embodiment of the present application may be, for example, a USB flash drive, but is not limited to electrical, magnetic, optical, electromagnetic, infrared, or semiconductor systems, devices, or apparatuses, or any combination thereof. More specific examples of the computer-readable storage medium may include, but are not limited to: electrical connections having one or more wires, portable computer disks, hard disks, random access memory (RAM), read-only memory (ROM), erasable programmable read-only memory (EPROM) or flash memory, optical fibers, portable compact disc read-only memory (CD-ROM), optical storage devices, magnetic storage devices, or any suitable combination thereof. In this embodiment, the computer-readable storage medium may be any tangible medium that includes or stores a program, which can be used by or in combination with an instruction execution system, device, or apparatus. The program code contained on the computer-readable storage medium may be transmitted via any appropriate medium, including but not limited to: electrical wires, optical cables, radio frequency (RF), or any suitable combination thereof.

The above computer-readable storage medium may be included in the clip-on earphone or may exist independently without being assembled into the clip-on earphone.

The above computer-readable storage medium carries one or more programs. When the one or more programs are executed by the clip-on earphone, the clip-on earphone performs the following: in response to detecting that the clip-on earphone is worn, obtaining three-axis acceleration information detected by a three-axis acceleration sensor; determining corresponding wearing positions of a first earphone and a second earphone according to the three-axis acceleration information; and based on the corresponding wearing positions of the first earphone and the second earphone, adjusting left and right channels of a speaker of the clip-on earphone so that the left channel corresponds to the earphone in a left ear wearing position, and the right channel corresponds to the earphone in a right ear wearing position.

The computer program code for performing the operations of the present disclosure may be written in one or more programming languages or a combination thereof. The programming languages include object-oriented programming languages such as Java, Smalltalk, and C++, as well as conventional procedural programming languages such as the C language or similar programming languages. The program code may be executed entirely on a user computer, partly on a user computer, as a stand-alone software package, partly on a user computer and partly on a remote computer, or entirely on a remote computer or server. In cases involving a remote computer, the remote computer may be connected to the user computer through any type of network, including a local area network (LAN) or a wide area network (WAN), or may be connected to an external computer, for example, via the Internet using an Internet service provider.

The flowcharts and block diagrams in the drawings illustrate possible system architectures, functions, and operations for implementing the systems, methods, and computer program products according to various embodiments of the present application. In this regard, each block in the flowcharts or block diagrams may represent a module, a program segment, or a portion of code that includes one or more executable instructions for implementing the specified logical function. It should also be noted that, in some alternative implementations, the functions noted in the blocks may occur in an order different from that shown in the drawings. For example, two blocks shown in succession may in fact be executed substantially concurrently, or they may sometimes be executed in reverse order, depending on the functions involved. It should also be noted that each block in the block diagrams and/or flowcharts, as well as combinations of blocks in the block diagrams and/or flowcharts, may be implemented by a dedicated hardware-based system that performs the specified functions or operations, or by a combination of dedicated hardware and computer instructions.

The modules involved in the embodiments of the present disclosure may be implemented in software or hardware. The names of the modules do not constitute limitations on the modules themselves in certain cases.

The computer-readable storage medium provided in the present application stores computer-readable program instructions for executing the above method for matching left and right channels of earphones. The solution can address the technical problem in the related art that requires manually confirming whether the left and right earphones are worn correctly, which leads to poor usability of clip-on earphones. Compared with the prior art, the beneficial effects of the computer-readable storage medium provided in the embodiment of the present application are the same as those of the method for matching left and right channels of earphones provided in the above embodiment, and therefore will not be described further herein.

The embodiment of the present application further provides a computer program product including a computer program. When executed by a processor, the computer program implements the steps of the method for matching left and right channels of earphones as described above.

The computer program product provided in the present application can address the technical problem in the related art that requires manually confirming whether the left and right earphones are worn correctly, which leads to poor usability of clip-on earphones. Compared with the prior art, the beneficial effects of the computer program product provided in the embodiment of the present application are the same as those of the method for matching left and right channels of earphones provided in the above embodiment, and therefore will not be described further herein.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A method for matching left and right channels of earphones, applied to a clip-on earphone, wherein a first earphone and a second earphone of the clip-on earphone are each provided with a three-axis acceleration sensor, the method comprising:
obtaining, in response to detecting that the clip-on earphone is worn, three-axis acceleration information detected by the three-axis acceleration sensor;
determining corresponding wearing positions of the first earphone and the second earphone according to the three-axis acceleration information; and
adjusting, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

2. The method according to claim 1, wherein the determining corresponding wearing positions of the first earphone and the second earphone according to the three-axis acceleration information comprises:
determining a component direction of the three-axis acceleration information in a vertical direction; and
determining the corresponding wearing positions of the first earphone and the second earphone according to the component direction.

3. The method according to claim 2, wherein the determining the corresponding wearing positions of the first earphone and the second earphone according to the component direction comprises:
determining wearing posture information corresponding to the first earphone and the second earphone according to the component direction; and
determining the corresponding wearing positions of the first earphone and the second earphone according to the wearing posture information.

4. The method according to claim 3, wherein the determining the corresponding wearing posture information of the first earphone and the second earphone according to the component direction comprises:
in response to that a component direction corresponding to three-axis acceleration information of the first earphone is a positive direction of a Z axis, determining that wearing posture information corresponding to the first earphone is a first posture;
in response to that a component direction corresponding to three-axis acceleration information of the first earphone is a negative direction of the Z axis, determining that wearing posture information corresponding to the first earphone is a second posture;
in response to that a component direction corresponding to three-axis acceleration information of the second earphone is the positive direction of the Z axis, determining that wearing posture information corresponding to the second earphone is the first posture; and
in response to that a component direction corresponding to three-axis acceleration information of the second earphone is the negative direction of the Z axis, determining that wearing posture information corresponding to the second earphone is the second posture.

5. The method according to claim 4, wherein the determining the corresponding wearing positions of the first earphone and the second earphone according to the wearing posture information comprises:
in response to that the wearing posture information corresponding to the first earphone is the first posture, determining that a wearing position corresponding to the first earphone is a left ear wearing position;
in response to that the wearing posture information corresponding to the first earphone is the second posture, determining that the wearing position corresponding to the first earphone is a right ear wearing position;
in response to that the wearing posture information corresponding to the second earphone is the first posture, determining that the wearing position corresponding to the second earphone is the left ear wearing position; and
in response to that the wearing posture information corresponding to the second earphone is the second posture, determining that the wearing position corresponding to the second earphone is the right ear wearing position.

6. The method according to claim 3, wherein the determining the corresponding wearing posture information of the first earphone and the second earphone according to the component direction comprises:
in response to that a component direction corresponding to three-axis acceleration information of the first earphone is a positive direction of a Z axis and a component value in the positive direction of the Z axis matches a gravity acceleration value, determining that wearing posture information corresponding to the first earphone is a first posture;
in response to that a component direction corresponding to three-axis acceleration information of the first earphone is a negative direction of the Z axis and a component value in a negative direction of the Z axis matches the gravity acceleration value, determining that wearing posture information corresponding to the first earphone is a second posture;
in response to that a component direction corresponding to three-axis acceleration information of the second earphone is the positive direction of the Z axis and a component value in the positive direction of the Z axis matches the gravity acceleration value, determining that wearing posture information corresponding to the second earphone is the first posture; and
in response to that a component direction corresponding to three-axis acceleration information of the second earphone is the negative direction of the Z axis and a component value in the negative direction of the Z axis matches the gravity acceleration value, determining that wearing posture information corresponding to the second earphone is the second posture.

7. The method according to claim 1, wherein the first earphone and the second earphone are each further provided with a capacitive touch sensor, and the method further comprises:
obtaining capacitance sensing information detected by the capacitive touch sensor; and
determining whether the clip-on earphone is worn according to the capacitance sensing information.

8. A device for matching left and right channels of earphones, applied to a clip-on earphone, wherein a first earphone and a second earphone of the clip-on earphone are each provided with a three-axis acceleration sensor, the device comprising:
an acquisition module configured to obtain, in response to detecting that the clip-on earphone is worn, three-axis acceleration information detected by the three-axis acceleration sensor;
a determination module configured to determine corresponding wearing positions of the first earphone and the second earphone according to the three-axis acceleration information; and
an adjustment module configured to, based on the corresponding wearing positions of the first earphone and the second earphone, left and right channels of a speaker of the clip-on earphone so that the left channel corresponds to the earphone in a left ear wearing position, and a right channel corresponds to the earphone in a right ear wearing position.

9. A clip-on earphone, comprising:
a memory, a processor, a behind-the-ear compartment, a speaker compartment, and a connecting bridge connecting the behind-the-ear compartment and the speaker compartment, wherein:
the speaker compartment is provided with an acoustic module comprising a speaker, and the behind-the-ear compartment is provided with a power supply module and an acceleration sensor;
the power supply module is configured to provide power to the clip-on earphone;
the acceleration sensor is configured to detect three-axis acceleration information of the clip-on earphone;
the memory is configured to store a program for matching left and right channels of earphones; and
the processor is configured to execute the program for matching left and right channels of earphones, and when executing the program for matching left and right channels of earphones, implement the method for matching left and right channels of earphones according to claim 1.

10. A non-transitory computer-readable storage medium, on which a program for implementing a method for matching left and right channels of earphones is stored, wherein when the program for implementing the method for matching left and right channels of earphones is executed by a processor, the method for matching left and right channels of earphones according to claim 1 is implemented.
